(19) United States
(12) Patent Application Publication
(10) Pub. No.: US 2014/0040460 A1
(43) Pub. Date: Feb. 6, 2014

(54) TRANSACTION DATA ACQUISITION METHOD, RECORDING MEDIUM, AND INFORMATION PROCESSING APPARATUS

(71) Applicant: FUJITSU LIMITED, Kawasaki-shi (JP)

(72) Inventors: Akihiko SAKURAI, Edogawa (JP); Eiji Mizunuma, Yokohama (JP); Atsushi Kaneko, Kani (JP); Hideki Gou, Numazu (JP); Kazutaka Taniguchi, Yokohama (JP); Takashi Yamashita, Kawasaki (JP); Takahiko Shirazawa, Akishima (JP)

(21) Appl. No.: 13/915,956

(22) Filed: Jun. 12, 2013

(30) Foreign Application Priority Data
Jul. 31, 2012 (JP) 2012-170169

(51) Int. Cl. H04L 12/26

(52) U.S. Cl. CPC H04L 43/0876
USPC 709/224

(57) ABSTRACT

An information processing apparatus executes a process and a second server in an information processing system including a first server, the second server, and a third server. The process includes: collecting, in a first queue, traffic data that is transmitted and received by the second server; acquiring, from the first server, a client request reception time when the first server receives a request from a client and a client response time when the first server responds to the request from the client; and moving, to a second queue, traffic data of a time period from a first server request reception time when the second server receives a request from the first server after the client request reception time to a first server response time when the second server responds to the request from the first server before the client response time.

### CROSS-REFERENCE TO RELATED APPLICATION

This application is based upon and claims the benefit of priority of the prior Japanese Patent Application No. 2012-170169, filed on Jul. 31, 2012, the entire contents of which are incorporated herein by reference.

### FIELD

The embodiments discussed herein are related to a transaction data acquisition method, a recording medium storing a transaction data acquisition program, and an information processing apparatus.

### BACKGROUND

Information technology (IT) systems such as web service systems operate 24 hours a day, 365 days a year. Such systems, however, are becoming larger and more complex. For a large system, there are no effective measures to totally, appropriately manage processed states of business tasks, and it has become difficult to detect a failure and specify a problem part. Thus, a business service management tool has been provided to detect an operational state of a large system.

The business service management tool generates an estimated model from a predefined filtering rule and data observed with a mirror port, and acquire transaction data from which a processed state and loaded state of each of business transactions are detected.

In order to set the filtering rule, however, transaction data to be acquired is detected. In addition, after the setting of the filtering rule, every time data to be observed is increased by changing the configuration of the system, adding an application, or the like, the filtering rule is updated.

Furthermore, in order to generate the estimated model, all traffic data is observed over a time period for the estimation, and results of the observation are stored. Thus, a load applied to the system is large, and the system may be requested to be updated by adding a high-speed, large-capacity server, or the like.

As examples of related art, Japanese Laid-open Patent Publication Nos. 2009-244948 and 09-128342 are known.

### SUMMARY

According to an aspect of the invention, a transaction data acquisition method that is executed by an information processing system that includes a first information processing apparatus on which a first server is executed, a second information processing apparatus on which a second server is executed, and a third information processing apparatus on which a third server is executed, includes: collecting by the first information processing apparatus, in a first server observation queue, traffic data that is transmitted and received by the first server; causing the first information processing apparatus to move, to a first server collection queue, first transaction data that includes traffic data of a time period from a client request reception time when the first server receives a request from a client to a client response time when the first server responds to the request from the client; collecting by the second information processing apparatus, in a second server observation queue, traffic data that is transmitted and received by the second server; acquiring by the second information processing apparatus, the client request reception time and the client response time from the first server; causing the second information processing apparatus to move, to a second server collection queue, second transaction data that includes transaction data of a time period from a first server request reception time when the second server receives a request from the first server after the client request reception time to a first server response time when the second server responds to the request from the first server before the client response time; collecting by the third information processing apparatus, in a third server observation queue, traffic data that is transmitted and received by the third server; acquiring by the third information processing apparatus, the first server request reception time and the first server response time from the second server; and causing the third information processing apparatus to move, to a third server collection queue, third transaction data that includes traffic data of a time period from a second server request reception time when the third server receives a request from the second server after the first server request reception time to a second server response time when the third server responds to the request from the second server before the first server response time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of an information processing system according to the first embodiment;

FIG. 2 is a diagram illustrating an example of the configuration of an information processing system according to the second embodiment;

FIG. 3 is a diagram illustrating an example of the arrangements of observing servers of computers according to the second embodiment;

FIG. 4 is a diagram illustrating an example of a hardware configuration of a host computer according to the second embodiment;

FIG. 5 is a flowchart of a process of storing traffic data according to the second embodiment;

FIG. 6 is a diagram illustrating an example of traffic data stored in an observation queue according to the second embodiment;

FIG. 7 is a flowchart of a process of narrowing down transaction data according to the second embodiment;

FIG. 8 is a flowchart of a process of specifying a range of traffic data to be acquired according to the second embodiment;

FIG. 9 is a flowchart of a process of generating a rule list according to the second embodiment;

FIG. 10 is a diagram illustrating an example of a rule list (first element) according to the second embodiment;

FIG. 11 is a diagram illustrating an example of a rule list (second element) according to the second embodiment;

FIG. 12 is a flowchart of a time narrowing down process according to the second embodiment;

FIG. 13 is a timing chart of an example of the time narrowing down process according to the second embodiment;

FIG. 14 is a flowchart of a target narrowing down process according to the second embodiment;

FIG. 15 is a diagram illustrating an example of the rule lists (first and second elements) according to the second embodiment;

FIG. 16 is a flowchart of a threshold narrowing down process according to the second embodiment;

FIG. 17 is a timing chart of an example of the threshold narrowing down process according to the second embodiment;

FIG. 18 is a flowchart of a forced acquisition process according to the second embodiment;

FIG. 19 is a diagram illustrating an example of the rule lists (first and second elements) according to the second embodiment;

FIG. 20 is a flowchart of a process of transferring transaction data according to the second embodiment;

FIG. 21 is a flowchart of a discovery coordination process according to the second embodiment;

FIG. 22 is a diagram illustrating an example of configured data to be referenced for the discovery coordination process according to the second embodiment;

FIG. 23 is a diagram illustrating an example of estimated data to be referenced for a transaction association technique coordination process.

FIG. 24 is a diagram illustrating an example of the arrangements of the observing servers of the computers according to the third embodiment; and

FIG. 25 is a diagram illustrating an example of the arrangement of observing servers of a computer according to the fourth embodiment.

### DESCRIPTION OF EMBODIMENTS

Hereinafter, the embodiments are described in detail with reference to the accompanying drawings.

### First Embodiment

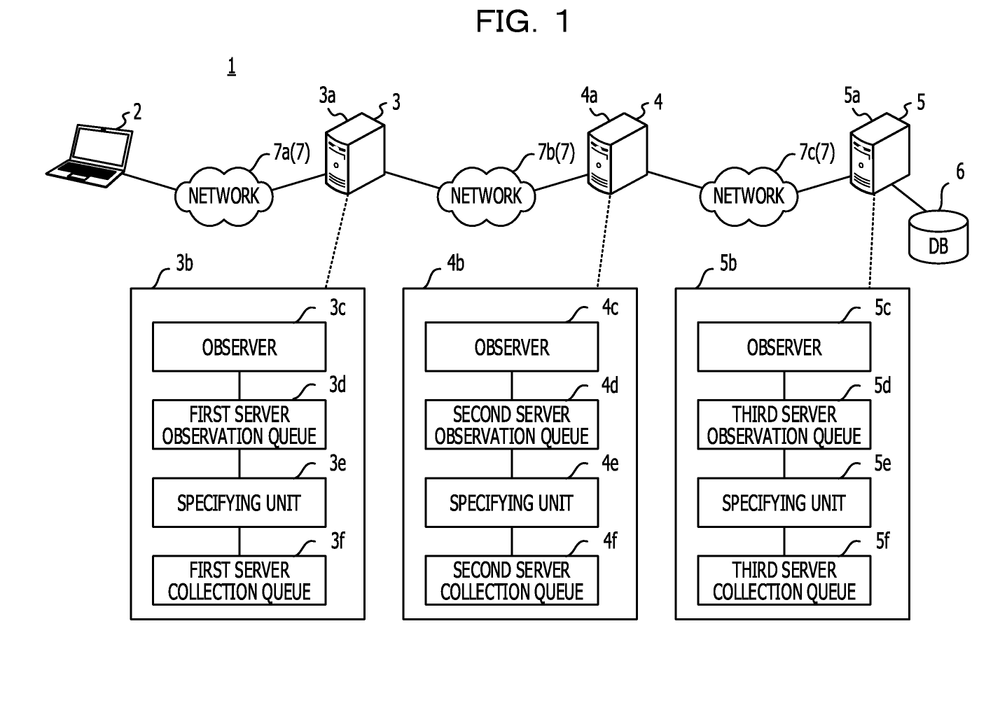

First, an information processing system 1 according to the first embodiment is described with reference to FIG. 1. FIG. 1 is a diagram illustrating an example of the configuration of the information processing system 1 according to the first embodiment.

The information processing system 1 provides a service response to a service request provided by a client 2. The information processing system 1 is a three-layer system that includes a first server 3a, a second server 4a, and a third server 5a. For example, the first server 3a functions as a presentation layer for providing a user interface to the client 2. The second server 4a functions as an application layer for executing a specific process. The third server 5a functions as a data layer for accessing a database (DB) 6.

An information processing apparatus 3 hosts the first server 3a and a first observing server 3b. An information processing apparatus 4 hosts the second server 4a and a second observing server 4b. An information processing apparatus 5 hosts the third server 5a and a third observing server 5b and is connected to the DB 6.

The information processing apparatus 3 is connected to and communicates with the client 2 through a network 7a. The information processing apparatuses 3 and 4 are connected to and communicate with each other through a network 7b. The information processing apparatuses 4 and 5 are connected to and communicate with each other through a network 7c.

The first observing server 3b observes traffic data that is transmitted and received by the first server 3a. The first observing server 3b acquires transaction data to be used to visualize transactions. The first observing server 3b has an observer 3c, a first server observation queue 3d, a specifying unit 3e, and a first server collection queue 3f.

The transaction data is a traffic data group generated due to a predetermined request. All data generated in relation to a request is a single transaction.

The observer 3c causes the traffic data that is transmitted and received by the first server 3a to be collected in the first server observation queue 3d. The specifying unit 3e specifies, as transaction data to be acquired, traffic data of a time period from a client request reception time to a client response time. The client request reception time is the time when the first server 3a receives a request from the client 2. The client response time is the time when the first server 3a responds to the request from the client 2. The specifying unit 3e moves the traffic data specified as the transaction data from the first server observation queue 3d to the first server collection queue 3f.

The second observing server 4b observes traffic data that is transmitted and received by the second server 4a. The second observing server 4b acquires transaction data to be used to visualize transactions. The second observing server 4b has an observer 4c, a second server observation queue 4d, a specifying unit 4e, and a second server collection queue 4f.

The observer 4c causes the traffic data that is transmitted and received by the second server 4a to be collected in the second server observation queue 4d. The specifying unit 4e acquires the client request reception time and the client response time from the first server 3a. The specifying unit 4e specifies, as transaction data to be acquired, traffic data of a time period from a first server request reception time to a first server response time. The first server request reception time is the time when the second server 4a receives a request from the first server 3a after the client request reception time. The first server response time is the time when the second server 4a responds to the request from the first server 3a before the client response time. The specifying unit 4e moves the traffic data specified as the transaction data from the second server observation queue 4d to the second server collection queue 4f.

The third observing server 5b observes traffic data that is transmitted and received by the third server 5a. The third observing server 5b acquires transaction data to be used to visualize transactions. The third observing server 5b has an observer 5c, a third server observation queue 5d, a specifying unit 5e, and a third server collection queue 5f.

The observer 5c causes the traffic data that is transmitted and received by the third server 5a to be collected in the third server observation queue 5d. The specifying unit 5e acquires the client response reception time and the client response time from the second server 4a. The specifying unit 5e specifies, as transaction data to be acquired, traffic data of a time period from a second server request reception time to a second server response time. The second server request reception time is the time when the third server 5a receives a request from the second server 4a after the first server request reception time. The second server response time is the time when the third server 5a responds to the request from the second server 4a before the first server response time. The specifying unit 5e moves the traffic data specified as the transaction data from the third server observation queue 5d to the third server collection queue 5f.

The information processing system 1 causes the first, second, and third observing servers 3b, 4b, and 5b to coordinate with each other and thereby collects the transaction data from the traffic data observed by the first, second, and third observing servers 3b, 4b, and 5b. Thus, the information processing system 1 narrows down the transaction data to be acquired, and thereby suppresses the capacity of a storage medium for storing transaction data.

The information processing system 1 narrows downs the transaction data to be acquired without defining transaction data to be acquired and setting a filter.

The information processing system 1 does not include an observing device for a mirror port for each of the information processing apparatuses 3, 4, and 5 segmented by the networks 7. In addition, the information processing system 1 does not include large-capacity storage and a high-speed computer for collection and storage of all data observed with a mirror port.

### Second Embodiment

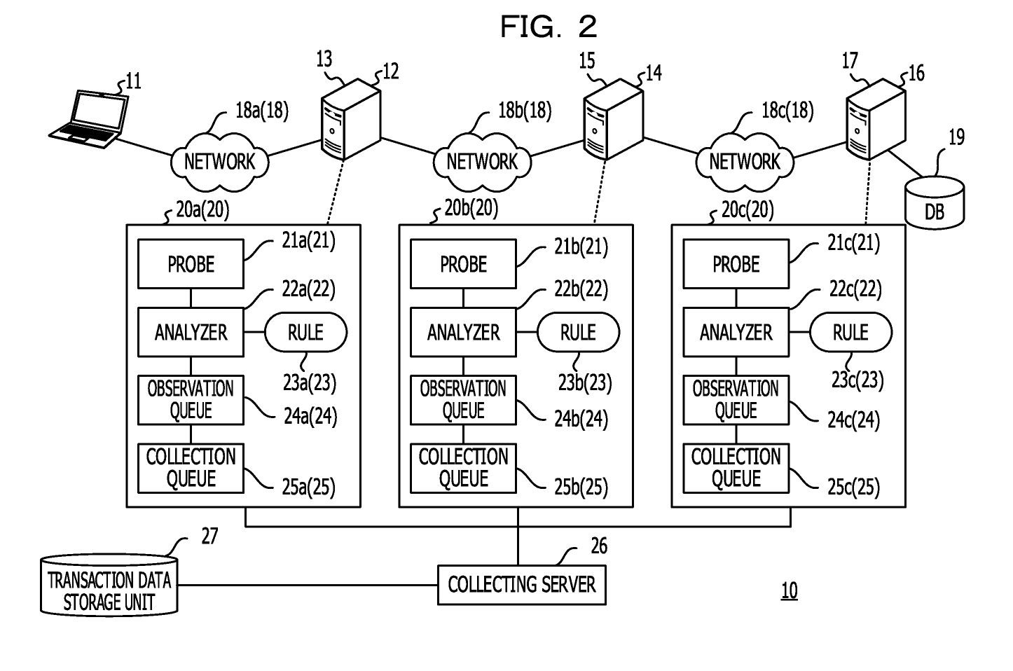

Next, the configuration of an information processing system 10 according to the second embodiment is described with reference to FIG. 2. FIG. 2 is a diagram illustrating an example of the configuration of the information processing system 10 according to the second embodiment.

The information processing system 10 provides a Hypertext Transfer Protocol (HTTP) response (service response) to an HTTP request (service request) provided by a client 11.

The information processing system 10 is a three-layer system that includes a world wide web (WWW) server 13, an application server 15, and a DB server 17.

The WWW server 13 is included in the computer 12. The computer 12 is connected to a client 11 through a network 18a and connected to a computer 14 through a network 18b. The WWW server 13 functions as a presentation layer for providing a user interface to the client 11 by a servlet for dynamically generating web pages and the like on the WWW server 13 and JavaServer Pages (JSP) (registered trademark) functioning as one function of the servlet.

The application server 15 is included in the computer 14. The computer 14 is connected to the computer 12 through the network 18b and connected to a computer 16 through a network 18c. The application server 15 is architected by Enterprise JavaBeans (EJB) (registered trademark) and functions as an application layer for executing a specific process (for example, a business application).

The DB server 17 is included in the computer 16. The computer 16 is connected to the computer 14 through the network 18c. The DB server 17 functions as a data layer and is a relational database (RDB) that is accessible to a DB 19.

The computers 12, 14, and 16 host observing servers 20a, 20b, and 20c, respectively. Specifically, the computer 12 hosts the observing server 20a for collecting traffic data (communication traffic) generated by the WWW server 13. The computer 14 hosts the observing server 20b for collecting traffic data generated by the application server 15. The computer 16 hosts the observing server 20c for collecting traffic data generated by the DB server 17.

The observing servers 20 (20a, 20b, and 20c) include probes 21 (21a, 21b, and 21c) and analyzers 22 (22a, 22b, and 22c), respectively. The probes 21 (21a, 21b, and 21c) collect traffic data of the servers targeted for data collection and cause the collected traffic data to be stored in observation queues 24 (24a, 24b, and 24c).

The analyzers 22 (22a, 22b, and 22c) analyze the traffic data stored in the observation queues 24 (24a, 24b, and 24c). The analyzers 22 (22a, 22b, and 22c) generate and update rules 23 (23a, 23b, and 23c), respectively, while the rules 23 (23a, 23b, and 23c) are used to determine effectiveness of the traffic data as transaction data.

The analyzers 22 (22a, 22b, and 22c) extract, from the observation queues 24 (24a, 24b, and 24c), traffic data that is effective as transaction data. The analyzers 22 (22a, 22b, and 22c) cause the extracted traffic data to be stored in collection queues 25 (25a, 25b, and 25c). The analyzers 22 (22a, 22b, and 22c) coordinate with each other and thereby extract the effective traffic data. In addition, the analyzers 22 (22a, 22b, and 22c) extract the traffic data on the basis of the rules 23 (23a, 23b, and 23c).

The transaction data stored in the collection queues 25 (25a, 25b, and 25c) is collected by a collecting server 26 and stored in a transaction data storage unit 27. The collecting server 26 may be included in any of the computers 12, 14, and 16 or may be included in another computer that is not illustrated.

Thus, the information processing system 10 does not include an observing device for a mirror port for each of the computers 12, 14, and 16 segmented by the networks 18. The information processing system 10 does not include large-capacity storage and a high-speed computer for collection and storage of all data observed with a mirror port. Specifically, the information processing system 10 acquires transaction data while reducing a load to be applied to the information processing system 10.

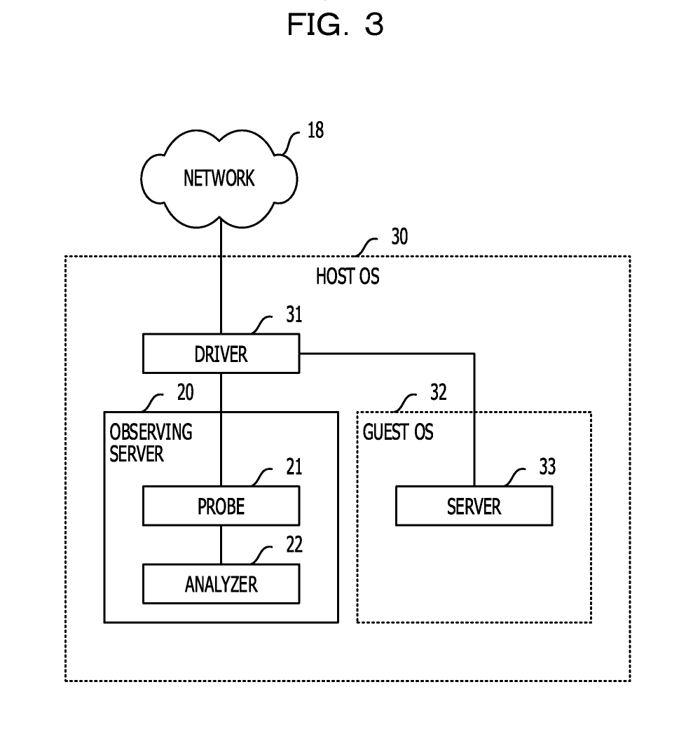

Next, the arrangements of the observing servers 20 according to the second embodiment are described with reference to FIG. 3. FIG. 3 is a diagram illustrating an example of the arrangements of the observing servers 20 of the computers 12, 14, and 16 according to the second embodiment.

Each of the computers 12, 14, and 16 executes the interested observing server 20 and at least one guest operating system (OS) 32 on a host OS 30. Each of the computers 12, 14, and 16 executes a server 33 on the guest OS 32. In this case, the server 33 is any of the WWW server 13, the application server 15 and the DB server 17. The server 33 communicates with an external device through a driver 31 and generates traffic data. The driver 31 controls a network interface card (NIC) (not illustrated) and is connected to and communicates with the networks 18.

Each of the observing servers 20 collects all traffic data of communication with an external device through the driver 31 by causing the probe 21 to observe the driver 31. The observing server 20 causes the analyzer 22 to acquire transaction data from all the collected traffic data.

In this manner, the observing server 20 collects all the traffic data of the server 33 executed on the guest OS 32.

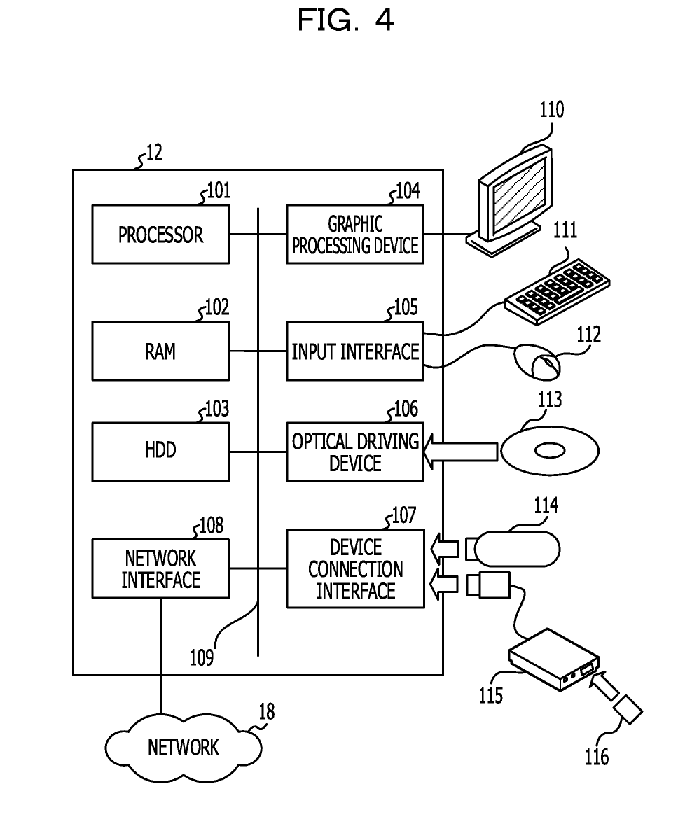

Next, a hardware configuration of the computer 12 according to the second embodiment is described with reference to FIG. 4. FIG. 4 is a diagram illustrating an example of the hardware configuration of the host computer 12 according to the second embodiment.

The overall computer 12 is controlled by a processor 101. The processor 101 is connected to a random access memory (RAM) 102 and a plurality of peripheral devices through a bus 109. The processor 101 may be a multiprocessor. For example, the processor 101 is a central processing unit (CPU), a micro processing unit (MPU), a digital signal processor (DSP), an application specific integrated circuit (ASIC), or a programmable logic device (PLD). The processor 101 may be a combination of two or more of the CPU, the MPU, the DSP, the ASIC, and the PLD.

The RAM 102 is used as a main storage device of the computer 12. At least a part of a program for an OS to be executed by the processor 101 and an application program is temporarily stored in the RAM 102. In addition, data of various types, which is used for a process to be executed by the processor 101, is stored in the RAM 102.

The peripheral devices that are connected to the bus 109 are an HDD, 103, a graphic processing device 104, an input interface 105, an optical driving device 106, a device connection interface 107, and a network interface 108.

The HDD 103 magnetically writes and reads data in and from a disk included in the HDD 103. The HDD 103 is used as an auxiliary storage device of the computer 12. The program for the OS, the application program, and the data of various types are stored in the HDD 103. As the auxiliary storage device, a semiconductor storage device such as a flash memory may be used.

The graphic processing device 104 is connected to a monitor 110. The graphic processing device 104 causes an image to be displayed on a screen of the monitor 110. Examples of the monitor 110 are a display device using a cathode ray tube (CRT) and a liquid crystal display device.

The input interface 105 is connected to a keyboard 111 and a mouse 112. The input interface 105 transmits, to the processor 101, signals received from the keyboard 111 and the mouse 112. The mouse 112 is an example of a pointing device. Another pointing device may be used instead of the mouse 112. Examples of the other pointing device are a touch panel, a tablet, a touch pad, and a trackball.

The optical driving device 106 uses laser light or the like to read data stored in an optical disc 113. The optical disc 113 is a portable recording medium storing data that is read by reflection of light. Examples of the optical disc 113 are a digital versatile disc (DVD), a DVD-RAM, a compact disc read only memory (CD-ROM), a CD-readable (CD-R), and a CD-rewritable (CD-RW).

The device connection interface 107 is a communication interface for connecting peripheral devices to the computer 12. For example, the device connection interface 107 is connected to a memory device 114 and a memory reader and writer 115. The memory device 114 is a recording medium that has a function of communicating with the device connection interface 107. The memory reader and writer 115 is a device that writes and reads data in and from a memory card 116. The memory card 116 is a card-type recording medium.

The network interface 108 is connected to the networks 18. The network interface 108 transmits and receives data to and from another computer or communication device through the networks 18. A network interface card (NIC) is an example of the network interface 108.

Processing functions of the computer 12 according to the second embodiment are achieved by the aforementioned hardware configuration. The information processing apparatuses 3, 4, and 5 described in the first embodiment and the computers 14 and 16 described in the second embodiment are each achieved by the same hardware as the computer 12 illustrated in FIG. 4.

The computer 12 achieves the processing functions according to the second embodiment by executing a program stored in a computer-readable recording medium. The program in which the contents of processes to be executed by the computer 12 are described is stored in various recording media. For example, the program to be executed by the computer 12 may be stored in the HDD 103. The processor 101 loads at least a part of the program stored in the HDD 103 into the RAM 102 and executes the program. In addition, the program to be executed by the computer 12 may be stored in portable recording media such as the optical disc 113, the memory device 114 and the memory card 116. The program stored in any of the portable recording media is installed in the HDD 103 in accordance with control of the processor 101. After the installation, the program may be executed by the computer 12. The processor 101 may directly read the program from any of the portable media and execute the program.

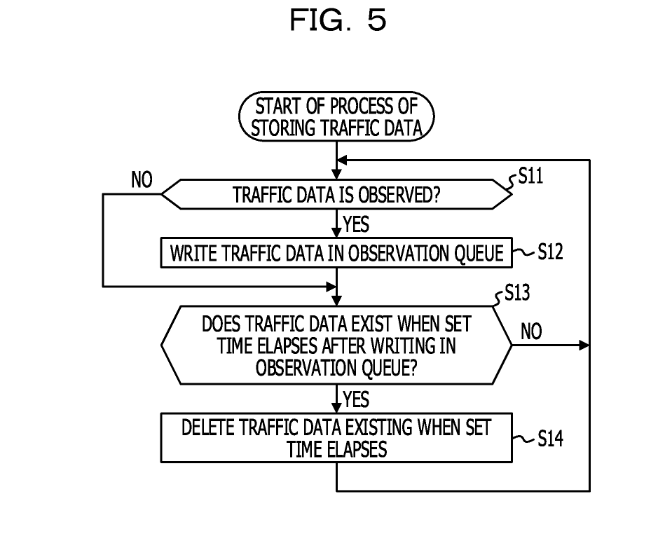

Next, a process of storing traffic data is described with reference to FIG. 5 and executed by the probe 21 according to the second embodiment. FIG. 5 is a flowchart of the process of storing traffic data according to the second embodiment.

The process of storing traffic data is a process of causing the observing server 20 to collect all traffic data to be observed and store the traffic data in the observation queue 24. The process of storing traffic data is executed by activation of the observing server 20.

In step S11, the probe 21 (observer) observes whether or not traffic data that passes through the driver 31 exists. If the probe 21 observes the traffic data, the probe 21 causes the process to proceed to step S12. If the probe 21 does not observe the traffic data, the probe 21 causes the process to proceed to step S13.

In step S12, the probe 21 causes the observed traffic data to be written (stored) in the observation queue 24.

In step S13, the probe 21 determines whether or not traffic data exists when a set time elapses after the writing in the observation queue 24. If the probe 21 determines that the traffic data exists when the set time elapses, the probe 21 causes the process to proceed to S14. If the probe 21 determines that the traffic data does not exist when the set time elapses, the probe 21 causes the process to return to S11.

In step S14, the probe 21 deletes, from the observation queue 24, the traffic data existing when the set time elapses. Then, the probe 21 causes the process to return to S11.

In this manner, the observing server 20 collects all traffic data to be observed and stores the traffic data in the observation queue 24. In addition, probe 21 deletes traffic data that is not moved to the collection queue 25 and exists when the set time elapses, since the traffic data is not used for transaction analysis. Thus, the observing server 20 holds, in the observation queue 24, transaction data to be acquired without an excessive increase in a storage region of the observation queue 24.

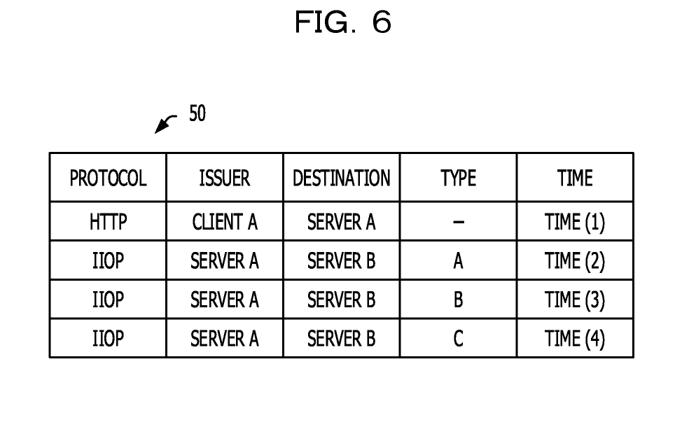

An example of the traffic data to be written in the observation queue 24 by the probe 21 according to the second embodiment is described with reference to FIG. 6. FIG. 6 is a diagram illustrating the example of the traffic data to be stored in the observation queue 24 according to the second embodiment.

Traffic data 50 is an example of traffic data accumulated in the observation queue 24 and is stored in a certain information recording device 8 that is, for example, the RAM 102, the HDD 103, or the like. The traffic data 50 includes items for protocols, issuers, destinations, types, and times.

The protocols are information identifying communication protocols of the traffic data and are protocol names such as “HTTP”, “IIOP”, and the like. The issuers are information identifying issuers of the traffic data and are computer names such as a “client A (client 11)”, a “server A (WWW server 13)”, and a “server B (application server 15)”. The destinations are information identifying destinations of the traffic data and are computer names such as the “client A”, the “server A”, and the “server B”. The issuers and the destinations may be Internet Protocol (IP) addresses, media access control (MAC) addresses, or the like, or may be combinations of multiple information pieces. The types are information that indicates the contents and states of the traffic data in detail. The types may be IP addresses, MAC addresses, URLs, or the like. For example, the types are “-”, “A”, “B”, “C”, and the like. The times indicate the times when the driver 31 receives the traffic data. The times are “time (1)”, “time(2)”, “time(3)”, “time(4)”, and the like. It is sufficient if the times identify a chronological order of the traffic data. Thus, the times may indicate the times when the traffic data is transmitted, the times when the traffic data is received, the times when the traffic data is collected, or the like.

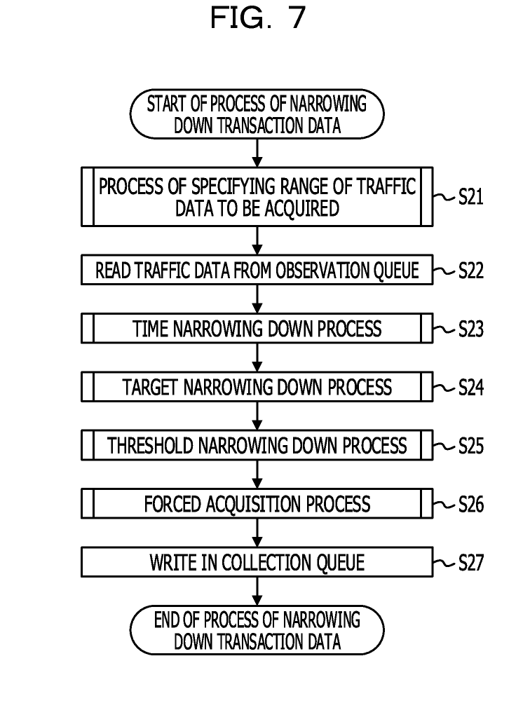

Next, a process of narrowing down transaction data is described with reference to FIG. 7. The process of narrowing down transaction data is executed by the analyzer 22 according to the second embodiment. FIG. 7 is a flowchart of the process of narrowing down transaction data according to the second embodiment.

The process of narrowing down transaction data is a process of specifying transaction data that is among traffic data stored in the observation queue 24 and is to be acquired and storing the specified transaction data in the collection queue 25. The process of narrowing down transaction data is executed periodically or randomly.

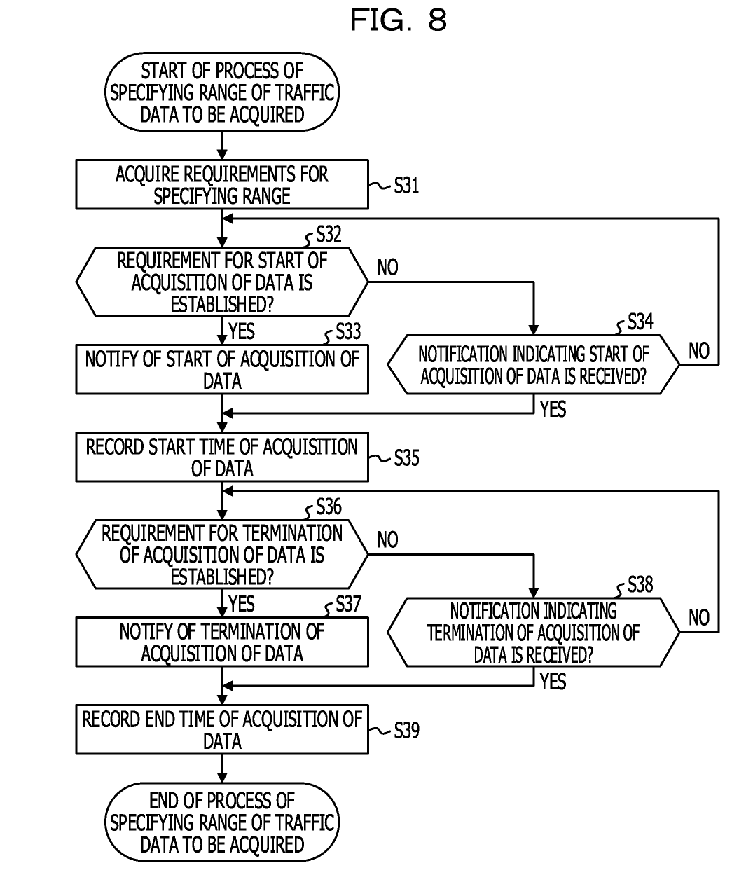

In step S21, the analyzer 22 (specifying unit) coordinates with the other analyzers 22 and executes a process of specifying a range of traffic data to be acquired. Thus, the analyzers 22a, 22b, and 22c coordinate with each other and specify the range of the traffic data to be acquired. Details of the process of specifying the range of the traffic data to be acquired are described later with reference to FIG. 8.

In step S22, the analyzer 22 reads, from the observation queue 24, the traffic data of which the range has been specified by the process of specifying a range of traffic data to be acquired, and deletes the read traffic data from the observation queue 24. The traffic data of which the range has been specified includes transaction data to be acquired and may include transaction data that is not to be acquired.

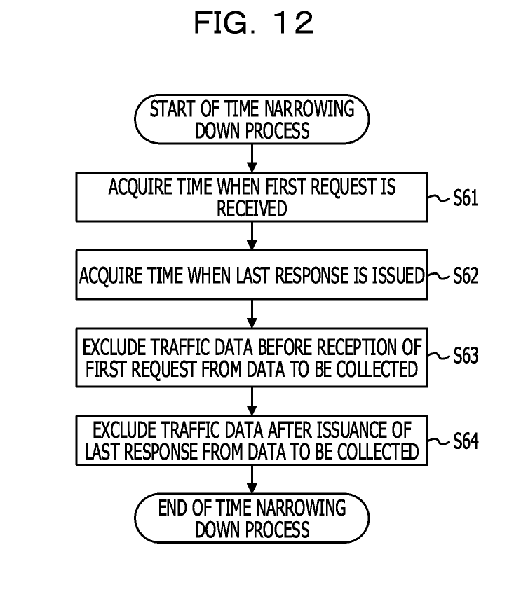

In step S23, the analyzer 22 executes a time narrowing down process. The analyzer 22 narrows down the traffic data by treating, as data (transaction data) to be acquired, traffic data of a time period from a predetermined request to a predetermined response, and by treating, as data not to be acquired, traffic data that does not exist within the time period from the predetermined request to the predetermined response. The time narrowing down process is to narrow (or reduce the amount of the traffic data) the traffic data of which the range has been specified down to traffic data of which a range is specified using times of the traffic data. Details of the time narrowing down process are described later with reference to FIG. 12.

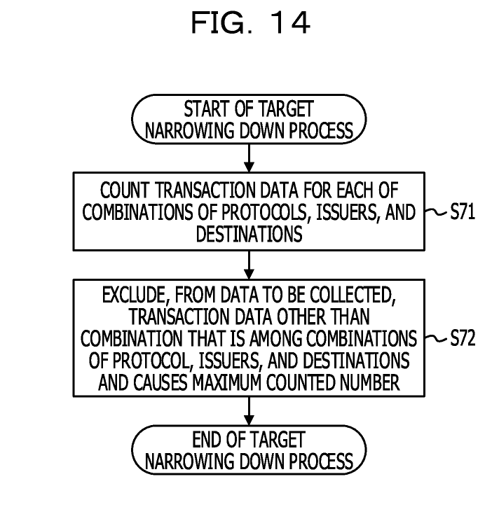

In step S24, the analyzer 22 executes a target narrowing down process. The analyzer 22 uses the number of times when transaction data is generated between a request and a response to exclude transaction data not to be acquired and thereby narrows transaction data down to transaction data to be acquired. Details of the target narrowing down process are described later with reference to FIG. 14.

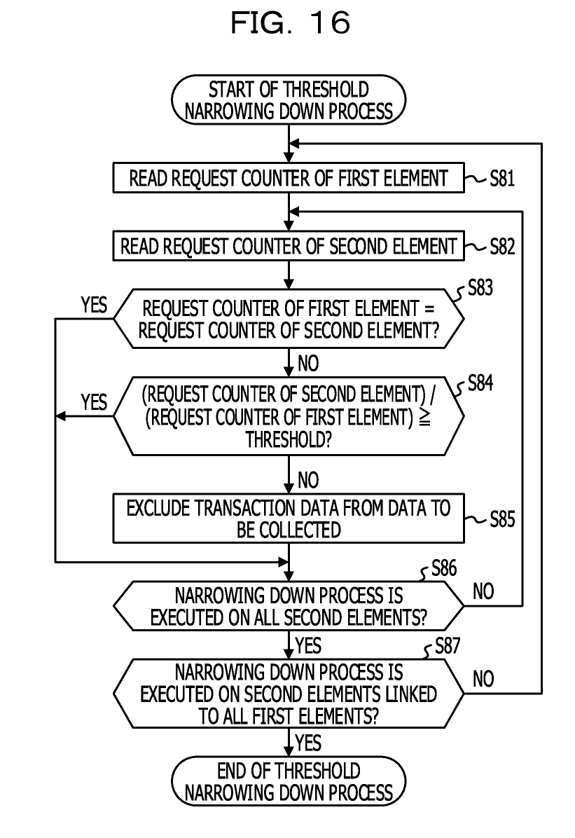

In step S25, the analyzer 22 executes a threshold narrowing down process. The analyzer 22 uses a set threshold and the number of the times when the transaction data is generated between the request and the response, excludes transaction data not to be acquired, and narrows the transaction data down to transaction data to be acquired. Details of the threshold narrowing down process are described later with reference to FIG. 16.

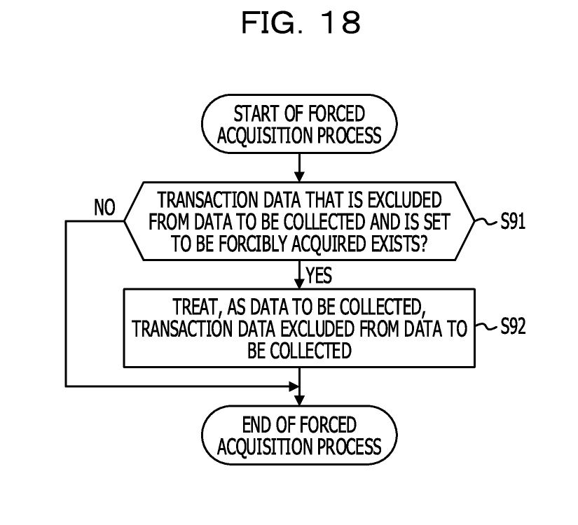

In step S26, the analyzer 22 executes a forced acquisition process. The analyzer 22 coordinates with a transaction association technique and a discovery, and forcibly treats transaction data as data to be acquired on a priority basis over the requirements for the other narrowing down processes. The discovery is periodically executed. Details of the forced acquisition process are described later with reference to FIG. 18.

In step S27, the analyzer 22 causes the transaction data obtained by narrowing down the transaction and to be acquired or the transaction data forcibly treated as the data to be acquired to be stored in the collection queue 25. After the storage of the transaction data in the collection queue 25, the analyzer 22 terminates the process of narrowing down transaction data.

Since the traffic data is periodically or randomly read and deleted from the observation queue 24, the observing server 20 holds, in the observation queue 24, transaction data to be acquired without an excessive increase in the storage region of the observation queue 24.

The transaction data stored in the collection queue 25 is the data obtained by narrowing down the traffic data read from the observation queue 24, and the observing server 20 does not excessively increase a storage region of the collection queue 25.

Next, the process of specifying the range of the traffic data to be acquired is described with reference to FIG. 8 and executed by the analyzer 22 according to the second embodiment. FIG. 8 is a flowchart of the process of specifying the range of the traffic data according to the second embodiment.

The process of specifying the range of the traffic data to be acquired is executed by causing the analyzer 22 to coordinate with the other analyzers 22. The process of specifying the range of the traffic data to be acquired is executed in step S21 of the process of narrowing down transaction data.

In step S31, the analyzer 22 (specifying unit) acquires requirements for specifying the range of the traffic data to be acquired. The requirements are requirements for specifying the range of the traffic data (to be acquired) by causing the analyzer 22 to coordinate with the other analyzers 22. The information processing system 10 generates a transaction that starts upon an HTTP request and ends upon an HTTP response. Thus, regarding the requirements for specifying the range of the traffic data to be acquired in the information processing system 10, the HTTP request that is transmitted to the WWW server 13 is used as a requirement for starting to acquire the data, and the HTTP response that is transmitted to the client 11 is used as a requirement for terminating the acquisition of the data.

The analyzers 22a, 22b, and 22c identify the servers (WWW server 13, application server 15, and DB server 17) to be observed and are executed on the basis of the types of the servers. The servers to be observed by the analyzers 22 may be identified from traffic data observed in accordance with an identification rule provided in advance, or the types of the servers to be observed may be set in advance.

In step S32, the analyzer 22 determines whether or not the requirement for starting the acquisition of the data is established. If the analyzer 22 determines that the requirement for starting the acquisition of the data is established, the analyzer 22 causes the process to proceed to step S33. If the analyzer 22 determines that the requirement for starting the acquisition of the data is not established, the analyzer 22 causes the process to proceed to step S34. In the information processing system 10, the analyzer 22a observes the WWW server 13 and determines that the requirement for starting the acquisition of the data is established.

In step S33, the analyzer 22 notifies the other coordinating analyzers 22 that the requirement for starting the acquisition of the data is established. For example, if the analyzer 22a determines that the requirement for starting the acquisition of the data is established, the analyzer 22a transmits, to the coordinating analyzers 22b and 22c, a notification that indicates the start of the acquisition of the data. The notification may be transmitted from the analyzer 22a to the analyzer 22b located at the next layer of the analyzer 22a and transmitted from the analyzer 22b to the analyzer 22c located at the next layer of the analyzer 22b.

In step S34, the analyzer 22 determines whether to receive, from the coordinating analyzers 22, the notification indicating the start of the acquisition of the data. If the analyzer 22 receives the notification indicating the start of the acquisition of the data, the analyzer 22 causes the process to proceed to step S35. If the analyzer 22 does not receive the notification indicating the start of the acquisition of the data, the analyzer 22 causes the process to return to step S32. In the information processing system 10, the analyzers 22b and 22c determine that the analyzers 22b and 22c receive the indicating the start of the acquisition of the data from the analyzer 22a.

In step S35, the analyzer 22 records the start time of the acquisition of the data.

In step S36, the analyzer 22 determines whether or not the requirement for terminating the acquisition of the data is established. If the analyzer 22 determines that the requirement for terminating the acquisition of the data is established, the analyzer 22 causes the process to proceed to step S37. If the analyzer 22 determines that the requirement for terminating the acquisition of the data is not established, the analyzer 22 causes the process to proceed to step S38. In the information processing system 10, the analyzer 22a observes the WWW server 13 and determines that the requirement for terminating the acquisition of the data is established.

In step S37, the analyzer 22 notifies the coordinating analyzers 22 that the requirement for terminating the acquisition of the data is established. For example, if the analyzer 22a determines that the requirement for terminating the acquisition of the data is established, the analyzer 22a transmits, to the coordinating analyzers 22b and 22c, a notification that indicates the termination of the acquisition of the data. The notification that indicates the termination of the acquisition of the data may be transmitted from the analyzer 22a to the analyzer 22b located at the next layer of the analyzer 22a and transmitted from the analyzer 22b to the analyzer 22c located at the next layer of the analyzer 22b.

In step S38, the analyzer 22 determines whether to receive the notification indicating the termination of the acquisition of the data from the coordinating analyzers 22. If the analyzer 22 receives the notification indicating the termination of the acquisition of the data, the analyzer 22 causes the process to proceed to step S39. If the analyzer 22 does not receive the notification indicating the termination of the acquisition of the data, the analyzer 22 causes the process to return to step S36. In the information processing system 10, the analyzers 22b and 22c determine that the analyzers 22b and 22c receive the notification indicating the termination of the acquisition of the data from the analyzer 22a.

In step S39, the analyzer 22 records the end time of the acquisition of the data and terminates the process of specifying the range of the traffic data to be acquired.

In this manner, the analyzer 22 coordinates with the other analyzers 22 and specifies the range of the traffic data to be acquired, and the information processing system 10 visualizes the transaction at the start of a service.

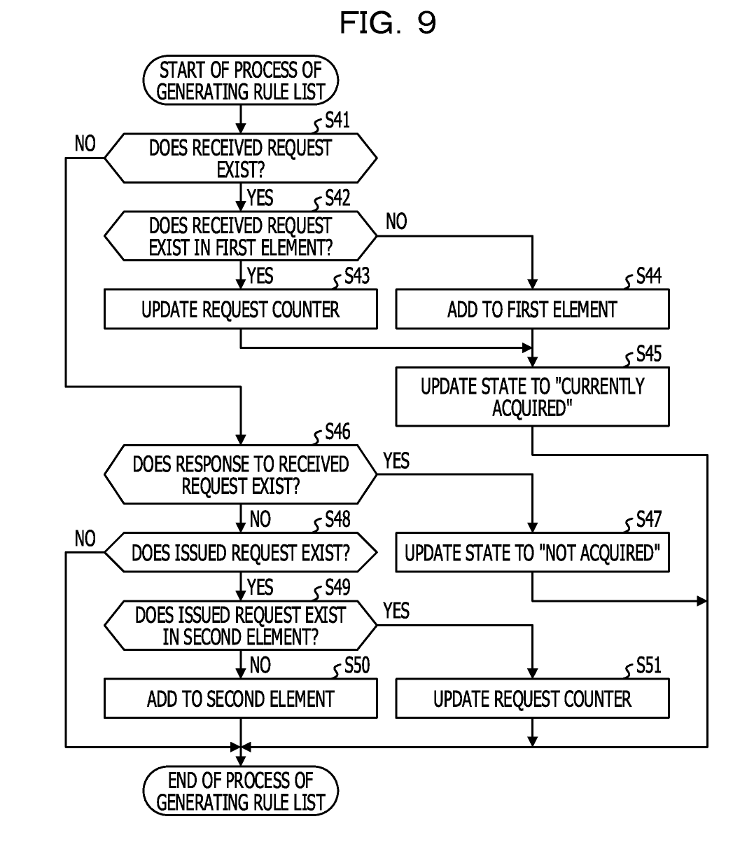

Next, a process of generating a rule list is described with reference to FIG. 9 and is executed by the analyzer 22 according to the second embodiment. FIG. 9 is a flowchart of the process of generating a rule list according to the second embodiment.

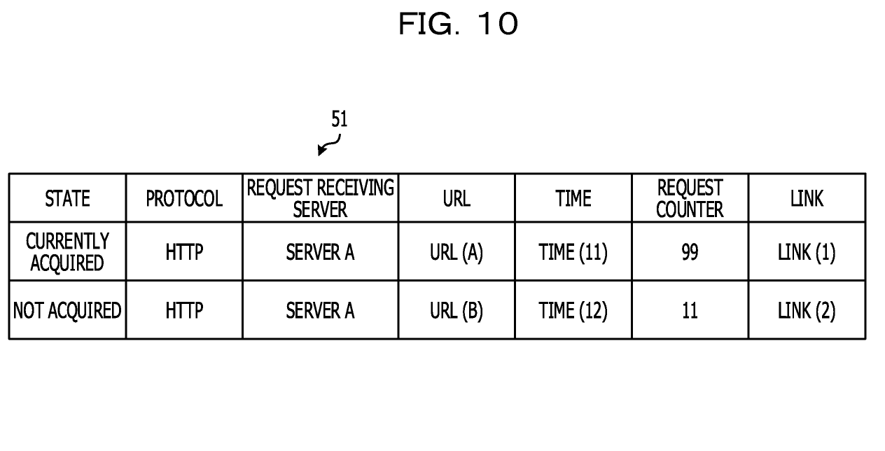

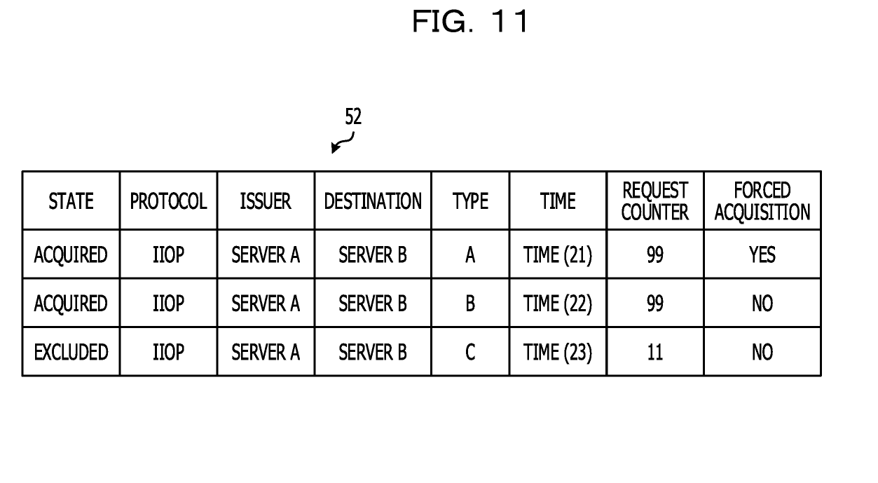

The process of generating a rule list is a process of generating information to be used to determine transaction data to be acquired and is executed periodically or randomly. The rule list has a layered structure as described later with reference to FIGS. 10 and 11. A rule list (first element) that forms the top layer is information listing requests transmitted to the server to be observed, while a rule list (second element) that forms the second layer is information listing requests issued by the server (to be observed) between the requests transmitted to the server to be observed and responses.

In step S41, the analyzer 22 (specifying unit) determines whether or not a request (received request) transmitted to the server to be observed exists. If the received request exists, the analyzer 22 causes the process to proceed to step S42. If the received request does not exist, the analyzer 22 causes the process to proceed to step S46.

In step S42, the analyzer 22 determines whether or not the received request is already registered in the rule list (first element). If the received request is already registered, the analyzer 22 causes the process to proceed to step S43. If the received request is yet to be registered, the analyzer 22 causes the process to proceed to step S44.

In step S43, the analyzer 22 updates request counters for registered received requests. Thus, the analyzer 22 detects the number of the generated received requests.

In step S44, the analyzer 22 additionally registers the received request in the rule list (first element).

In step S45, the analyzer 22 updates the state of the received request registered in the rule list (first element) to “currently acquired”.

In step S46, the analyzer 22 determines whether or not a response to the received request exists. If the response to the received request exists, the analyzer 22 causes the process to proceed to step S47. If the response to the received request does not exist, the analyzer 22 causes the process to proceed to step S48.

In step S47, the analyzer 22 updates the state of the received request registered in the rule list (first element) from “currently acquired” to “not acquired”.

In step S48, the analyzer 22 determines whether or not a request (issued request) transmitted from the server to be observed exists. If the issued request exists, the analyzer 22 causes the process to proceed to step S49. If the issued request does not exist, the analyzer 22 terminates the process of generating a rule list.

In step S49, the analyzer 22 determines whether or not the issued request is already registered in the rule list (second element). If the issued request is already registered, the analyzer 22 causes the process to proceed to step S51. If the issued request is yet to be registered, the analyzer 22 causes the process to proceed to step S50.

In step S50, the analyzer 22 additionally registers the issued request in the rule list (second element). Then, the analyzer 22 terminates the process of generating a rule list.

In step S51, the analyzer 22 updates request counters for registered issued requests. Thus, the analyzer 22 detects the number of the requests issued between the request transmitted to the server to be observed and a response.

Next, an example of the rule list (first element) according to the second embodiment is described with reference to FIG. 10. FIG. 10 is a diagram illustrating the example of the rule list (first element) according to the second embodiment. A rule list (first element) 51 is an example of the rule list (first element) generated by the analyzer 22a.

The observing server 20a that has the analyzer 22a observes the WWW server 13. Thus, the analyzer 22a observes, as the received request, an HTTP request transmitted from the client 11 and observes, as the issued request, an IIOP request transmitted to the application server 15.

The rule list (first element) 51 includes items for states, protocols, request receiving servers, uniform resource locators (URL), times, request counters, and links. The states indicate acquisition states of the rule list (first element) 51 for received requests serving as start points. In the item for states, “currently acquired” and “not acquired” are indicated. The protocols are protocols of the requests received by the WWW server 13 to be observed by the observing server 20a. In the rule list 51, a protocol “HTTP” indicates that the WWW server 13 has received an HTTP request.

The request receiving servers are information that identifies servers that have received the requests. For example, the request receiving servers are indicated by computer names such as the “server A (WWW server 13)” and the like. The URLs are information that identifies resources, included in the requests, of the server A. For example, the URLs are “URL (A)”, “URL (B)” and the like. The times are information that identifies a chronological order of the requests. For example, the times indicate the times when the server A receives the requests, and are indicated by “time (11)”, “time (12)”, and the like. The request counters are counter values that are updated in the process of generating a rule list. The links are information that identifies the rule list (second element) associated to the requests. For example, the links are indicated by links “LNK (1)”, “LNK (2)”, and the like to the rule list (second element) forming the second layer.

Next, an example of the rule list (second element) according to the second embodiment is described with reference to FIG. 11. FIG. 11 is a diagram illustrating the example of the rule list (second element) according to the second embodiment. A rule list (second element) 52 is an example of the rule list (second element) generated by the analyzer 22a.

The rule list (second element) 52 includes items for states, protocols, issuers, destinations, types, times, request counters, and forced acquisition. The states indicate whether or not requests are to be collected as transactions. The item for states, “acquired” and “excluded” are indicated. The protocols indicate protocols of the requests issued by the WWW server 13 to be observed by the observing server 20a. A protocol “IIOP” indicates that the WWW server 13 has issued an IIOP request. The issuers are information that identifies servers that has issued the requests. For example, the item for issuers indicates a computer name such as the “server A (WWW server)”. The destinations are information that identifies servers that are destinations of the requests. For example, the item for destinations indicates a computer name such as the “server B (application server 15)”. The types are information to be used to distinguish the contents or states of the requests in detail. The types may be information identifying objects. For example, the types are indicated by “A”, “B”, “C”, and the like. The times are information that specifies a chronological order of the requests. For example, the times indicate times when the server A issues the requests. The times are indicated by “time (21)”, “time (22)”, “time (23)”, and the like, for example. The forced acquisition is information indicating whether or not the requests are to be forcibly acquired regardless of the items (for states, protocols, issuers, destinations, types, times, and request counters) of the rule list (second element) 52. For example, the item for forced acquisition indicates “YES” and “NO”.

The rule list (first element) 51 and the rule list (second element) 52 are valid during the time when the observing server 20a is executed. If elements of the rule lists (first and second elements) 51 and 52 are not updated for a predetermined time period (of, for example, one month) or rules for the elements are not applied for the predetermined time period, the analyzer 22a may delete the elements.

The generation of the rule lists (first and second elements) 51 and 52 by the analyzer 22a is described above. The analyzers 22b and 22c may generate rule lists (first and second elements) in the same manner.

Next, a time narrowing down process that is executed by the analyzer 22 according to the second embodiment is described with reference to FIG. 12. FIG. 12 is a flowchart of the time narrowing down process according to the second embodiment.

The time narrowing down process is a process of narrowing down transaction data (to be acquired) by acquiring transaction data of a time period (acquisition target time period) from a received request to a response to the received request while not acquiring other transaction data. The time narrowing down process is executed in step S23 of the process of narrowing down transaction data.

In step S61, the analyzer 22 (specifying unit) acquires the time when a first request is received. The time when the first request is received is the time when the request that serves as a start point of transaction collection is received. For example, the analyzer 22a acquires, as the time when the first request is received, the time when the WWW server 13 receives an HTTP request. After receiving a notification indicating the start of the acquisition of the data from the analyzer 22a, the analyzer 22b acquires, as the time when the first request is received, the time when the application server 15 receives an IIOP request. After receiving the notification indicating the start of the acquisition of the data from the analyzer 22a or 22b, the analyzer 22c acquires, as the time when the first request is received, the time when the DB server 17 receives an SQL request.

In step S62, the analyzer 22 acquires the time when the last response is issued. The time when the last response is issued is the end point of the transaction collection and is the time when the response to the first request is issued. For example, before receiving a notification indicating termination of the acquisition of the data from the analyzer 22a or 22b, the analyzer 22c acquires, as the time when the last response is issued, the time when the DB server 17 issues an SQL response. Before receiving the notification indicating the termination of the acquisition of the data from the analyzer 22a, the analyzer 22b acquires, as the time when the last response is issued, the time when the application server 15 issues an IIOP response. The analyzer 22a acquires, as the time when the last response is issued, the time when the WWW server 13 issues an HTTP response.

In step S63, the analyzer 22 excludes, from data to be collected, traffic data before the time when the first request is received.

In step S64, the analyzer 22 excludes, from the data to be collected, traffic data after the last response is issued. Then, the analyzer 22 terminates the time narrowing down process.

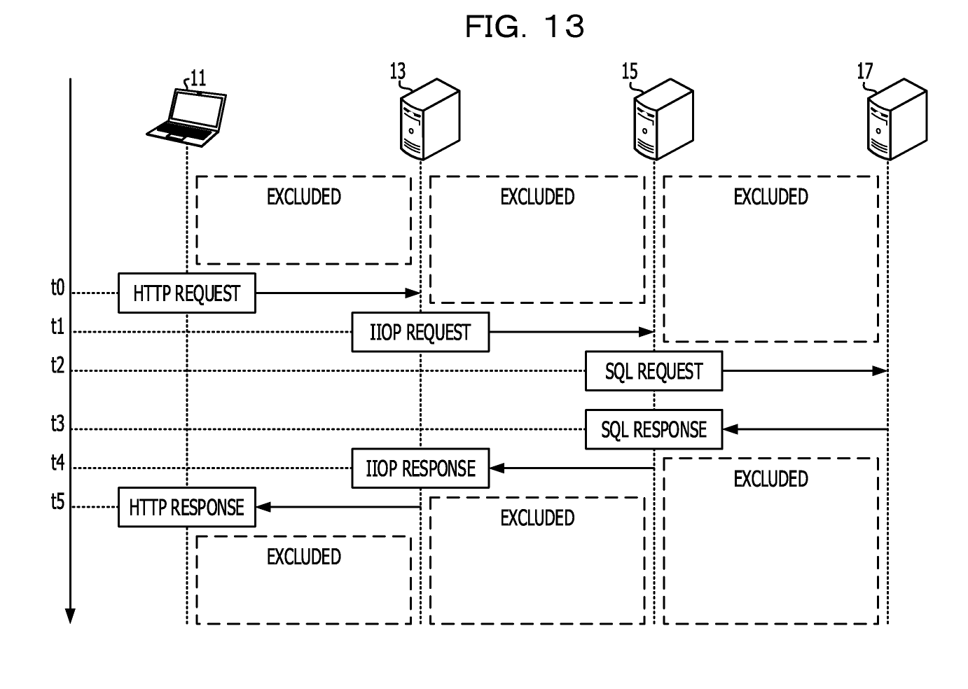

Next, an example of the time narrowing down process that is executed by the analyzer 22 according to the second embodiment is described with reference to FIG. 13. FIG. 13 is a timing chart of the example of the time narrowing down process according to the second embodiment.

The client 11 issues an HTTP request to the WWW server 13. The WWW server 13 receives the HTTP request at a time t0. The analyzer 22a detects, at the time to, the HTTP request received by the WWW server 13 and notifies the analyzers 22b and 22c of the start of acquisition of data.

The WWW server 13 issues an IIOP request to the application server 15. The application server 15 receives the IIOP request at a time t1. The analyzer 22b detects the IIOP request received by the application server 15 at the time t1 after the reception of the notification indicating the start of the acquisition of the data.

The application server 15 issues an SQL request to the DB server 17. The DB server 17 receives the SQL request at a time t2. The analyzer 22c detects the SQL request received by the DB server 17 at the time 2 after the reception of the notification indicating the start of the acquisition of the data.

The DB server 17 issues an SQL response to the application server 15 at a time t3. The analyzer 22c detects the SQL response issued by the DB server 17 at the time 3.

The application server 15 issues an IIOP response to the WWW server 13 at a time t4. The analyzer 22b detects the IIOP response issued by the application server 15 at the time t4.

The WWW server 13 issues an HTTP response to the client 11 at a time t5. The analyzer 22a detects the HTTP response issued by the WWW server 13 at the time t5 and notifies the analyzers 22b and 22c of the termination of the acquisition of the data.

Thus, the analyzer 22a narrows data to be acquired down to transaction data of a time period from the time t0 to the time t5. In addition, the analyzer 22b narrows the data to be acquired down to transaction data of a time period from the time t1 to the time 4. The analyzer 22c narrows the data to be acquired down to transaction data of a time period from the time t2 to the time t3.

Next, the target narrowing down process that is executed by the analyzer 22 according to the second embodiment is described with reference to FIG. 14. FIG. 14 is a flowchart of the target narrowing down process according to the second embodiment.

The target narrowing down process is a process of narrowing down the data (to be collected) using the number of times when transaction data is generated between the start of acquisition of data and the termination of the acquisition of the data (or between detection of an HTTP request and detection of an HTTP response). The target narrowing down process is executed in step S24 of the process of narrowing down transaction data.

In step S71, the analyzer 22 (specifying unit) counts transaction data for each of combinations of protocols, issuers, and destinations.

In step S72, the analyzer 22 excludes, from the data to be collected, transaction data other than data corresponding to a combination that is among the combinations of the protocols, the issuers, and the destinations and causes the maximum counted number. Then, the analyzer 22 terminates the target narrowing down process.

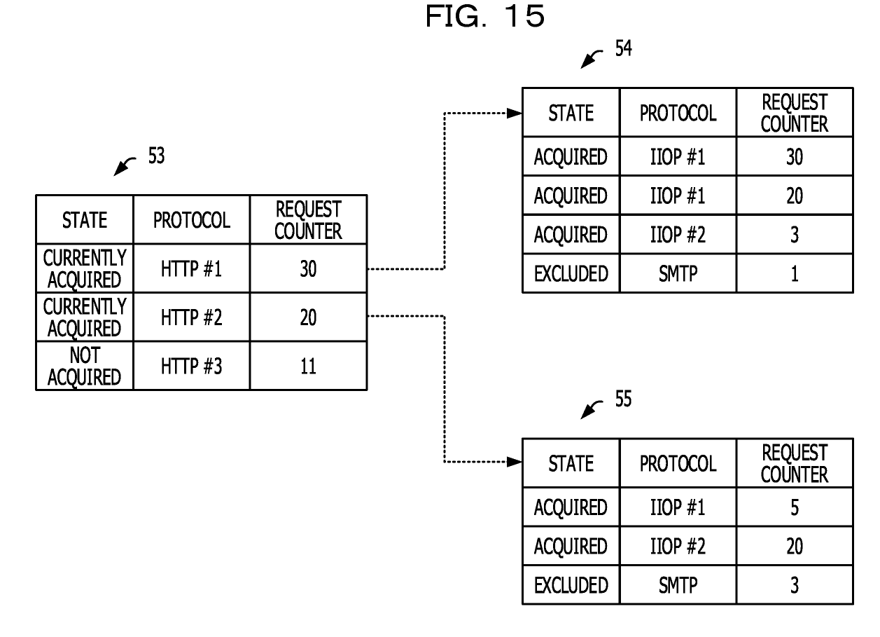

Next, a process of narrowing down transaction data according to the second embodiment is described with reference to FIG. 15. FIG. 15 is a diagram illustrating an example of rule lists (first and second elements) according to the second embodiment.

A part of the items included in the rule list (first element) 51 is omitted in a rule list (first element) 53. In the rule list (first element) 53, the state of a protocol “HTTP #1” indicates “currently acquired”, a request counter for the protocol “HTTP #1” indicates “30”, the state of a protocol “HTTP #2” indicates “currently acquired”, a request counter for the protocol “HTTP #2” indicates “20”. In the rule list (first element) 53, the state of a protocol “HTTP #3” indicates “not acquired”, and a request counter for the protocol “HTTP #3” indicates “11”.

A part of the items included in the rule list (second element) 52 is omitted in a rule list (second element) 54. In the rule list (second element) 54, the state of a protocol “IIOP #1” indicates “acquired”, a request counter for the protocol “IIOP #1” indicates “30”, the state of another protocol “IIOP #1” indicates “acquired”, and a request counter for the other protocol “IIOP #1” indicates “20”. In the rule list (second element) 54, the state of a protocol “IIOP #2” indicates “acquired”, a request counter for the protocol “IIOP #2” indicates “3”, the state of a protocol “SMTP” indicates “excluded”, and a request counter for the protocol “SMTP” indicates “1”.

A part of the items included in the rule list (second element) 52 is omitted in a rule list (second element) 55. In the rule list (second element) 55, the state of a protocol “IIOP #1” indicates “acquired”, a request counter for the protocol “IIOP #1” indicates “5”, the state of the protocol “IIOP #2” indicates “acquired”, and a request counter for the protocol “IIOP #2” indicates “20”. In rule list (second element) 55, the state of the protocol “SMTP” indicates “excluded”, and a request counter for the protocol “SMTP” indicates “3”.

In this manner, the analyzer 22a treats, as data to be collected, data of “IIOP” causing the maximum number of the request counter and excludes data of “SMTP” other than “IIOP” from the data to be collected. Thus, the information processing system 10 excludes unwanted transaction data.

Next, the threshold narrowing down process that is executed by the analyzer 22 according to the second embodiment is described with reference to FIG. 16. FIG. 16 is a flowchart of the threshold narrowing down process according to the second embodiment.

The threshold narrowing down process is a process of narrowing down data to be acquired using a set threshold and the number of the times when the transaction data is generated between the start of the acquisition of the data and the termination of the acquisition of the data (or between the detection of the HTTP request and the detection of the HTTP response). The threshold narrowing down process is executed in step S25 of the process of narrowing down transaction data.

In step S81, the analyzer 22 (specifying unit) reads a request counter for an element of the rule list (first element).

In step S82, the analyzer 22 reads a request counter for an element that is included in the rule list (second element) and linked to the element read in step S81 and included in the rule list (first element).

In step S83, the analyzer 22 compares the request counter, read in step S81, of the first element with the request counter, read in step S82, of the second element. If the request counter of the first element is equal to the request counter of the second element, the analyzer 22 causes the process to proceed to step S86. If the request counter of the first element is not equal to the request counter of the second element, the analyzer 22 causes the process to proceed to step S84.

In step S84, the analyzer 22 compares a value (divided value) obtained by dividing the request counter, read in step S82, of the second element by the request counter, read in S81, of the first element with the set threshold. If the divided value is equal to or larger than the threshold, the analyzer 22 causes the process to proceed to step S86. If the divided value is smaller than the threshold, the analyzer 22 causes the process to proceed to step S85.

In step S85, the analyzer 22 excludes, from the data to be collected, transaction data corresponding to the element of the rule list (second element).

In step S86, the analyzer 22 determines whether or not the process of narrowing down data to be collected is executed on elements included in all rule lists (second elements) and linked to the element, read in step S81, of the rule list (first element). If the process of narrowing down data to be collected is executed on the elements of all the rule lists (second elements), the analyzer 22 causes the process to proceed to step S87. On the other hand, if the process of narrowing down data to be collected is not executed on any of the elements of all the rule lists (second elements), the analyzer 22 causes the process to proceed to step S82 in order to execute the process of narrowing down data to be collected on the element included in the rule list (second element) and yet to be subjected to the narrowing down process.

In step S87, the analyzer 22 determines whether or not the process of narrowing down data to be collected is executed on the rule lists (second elements) linked to elements of all rule lists (first elements). If the process of narrowing down data to be collected is executed on the rule lists (second elements) linked to the elements of all the rule lists (first elements), the analyzer 22 terminates the threshold narrowing down process. If the process of narrowing down data to be collected is not executed on the rule lists (second elements) linked to the elements of all the rule lists (first elements), the analyzer 22 causes the process to return to step S81 in order to execute the process of narrowing down data to be collected on an element of a rule list (first element) linked to a rule list (second element) yet to be subjected to the narrowing down process.

The threshold that is used in the threshold narrowing down process may be an externally defined value or a ratio, for example, 25% of the number of HTTP requests.

The threshold narrowing down process may be executed when the notification that indicates the termination of the acquisition of the data is transmitted using an HTTP response or received.

In this manner, the analyzers 22 nest a request and a response or generate a cross-origin request and a cross-origin response so as to execute transaction data included in read traffic data and not to be acquired and narrow down transaction data to be acquired.

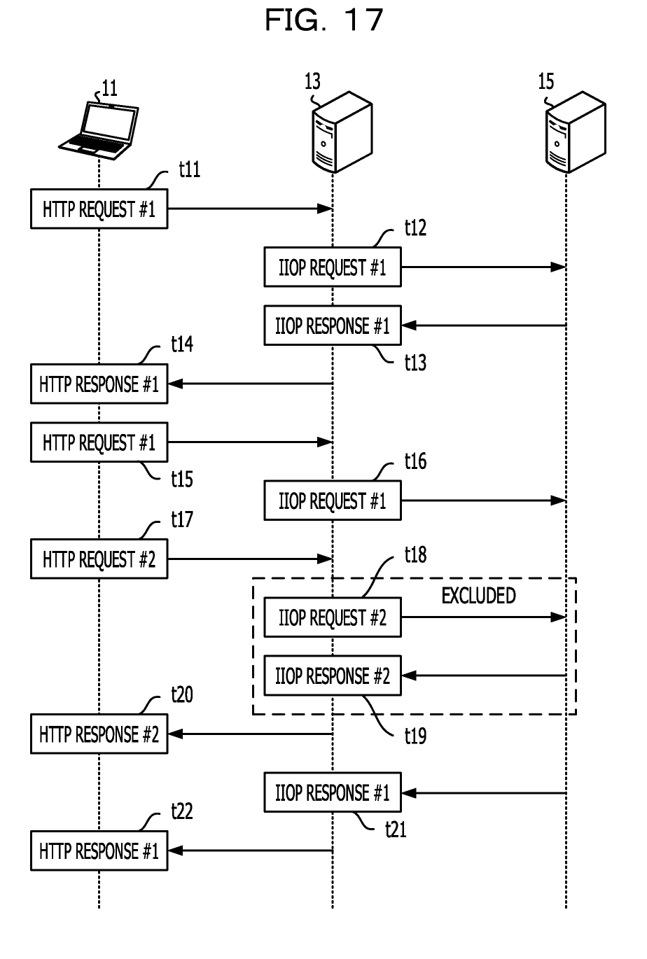

Next, an example of the threshold narrowing down process that is executed by the analyzer 22 according to the second embodiment is described with reference to FIG. 17. FIG. 17 is a timing chart of the example of the threshold narrowing down process according to the second embodiment. An SQL sequence between the application server 15 and the DB server 17 is the same as an SQL sequence between the WWW server 13 and the application server 15, and thus omitted in FIG. 17 in order to simplify the following description.

The client 11 issues an HTTP request #1 (t11) to the WWW server 13. The WWW server 13 receives the HTTP request #1 (t11) and issues an IIOP request #1 (t12) to the application server 15. The WWW server 13 receives an IIOP response #1 (t13) from the application server 15 and issues an HTTP response #1 (t14) to the client 11.

As is apparent from above, another request and another response are not provided between the HTTP request #1 (t11) and the HTTP response #1 (t14). In this case, the analyzer 22a treats, as data to be collected, transaction data between the HTTP request #1 (t11) and the HTTP response #1 (t14).

The client 11 issues an HTTP request #1 (t15) to the WWW server 13. The WWW server 13 receives the HTTP request #1 (t15) and issues an IIOP request #1 (t16) to the application server 15. The client 11 issues an HTTP request #2 (t17) to the WWW server 13. The WWW server 13 receives the HTTP request #2 (t17) and issues an IIOP request #2 (t18) to the application server 15. The WWW server 13 receives an IIOP response #2 (t19) from the application server 15 and issues an HTTP response #2 (t20) to the client 11. The WWW server 13 receives an IIOP response #1 (t21) from the application server 15 and issues an HTTP response #1 (t22) to the client 11.

As is apparent from above, the other request and response of which a start point is the HTTP request #2 (t17) are provided between the HTTP request #2 (t17) and the HTTP response #2 (t20). In this case, the analyzer 22a executes the threshold narrowing down process and thereby excludes the IIOP request #2 (t18) and the IIOP response #2 (t19) from data to be collected. Thus, the analyzer 22a excludes the transaction data that is not to be acquired and is nested between the HTTP request #2 (t17) and the HTTP response #2 (t20).

The case where the threshold narrowing down process is executed by the analyzer 22a is described as an example. The same applies to the analyzers 22b and 22c.

Next, the forced acquisition process that is executed by the analyzer 22 according to the second embodiment is described with reference to FIG. 18. FIG. 18 is a flowchart of the forced acquisition process according to the second embodiment.

The forced acquisition process is a process of forcibly acquiring transaction data regardless of the time narrowing down process, the target narrowing down process, and the threshold narrowing down process. The information processing system 10 causes the analyzers 22 to observe and analyze transaction data and use a rule list generated by the analysis to narrow the transaction data down to data to be acquired, adds an acquisition rule provided by another system to the rule list, and improves the accuracy of the collection. The forced acquisition process is executed in step S26 of the process of narrowing down transaction data.

In step S91, the analyzer 22 (specifying unit) determines whether or not transaction data that is excluded from data to be collected and is set to be forcibly acquired exists. Whether or not the transaction data that is set to be forcibly acquired exists is determined by referencing the forced acquisition item of the rule list (second element). If the transaction data is to be forcibly acquired, the analyzer 22 causes the process to proceed to step S92. If the transaction data is not to be forcibly acquired, the analyzer 22 terminates the forced acquisition process.

In step S92, the analyzer 22 treats, as the data to be collected, the transaction data excluded from the data to be collected. Then, the analyzer 22 terminates the forced acquisition process.

Thus, the information processing system 10 collaborates with the discovery and the transaction association technique and achieves high-accuracy collection of transaction data.

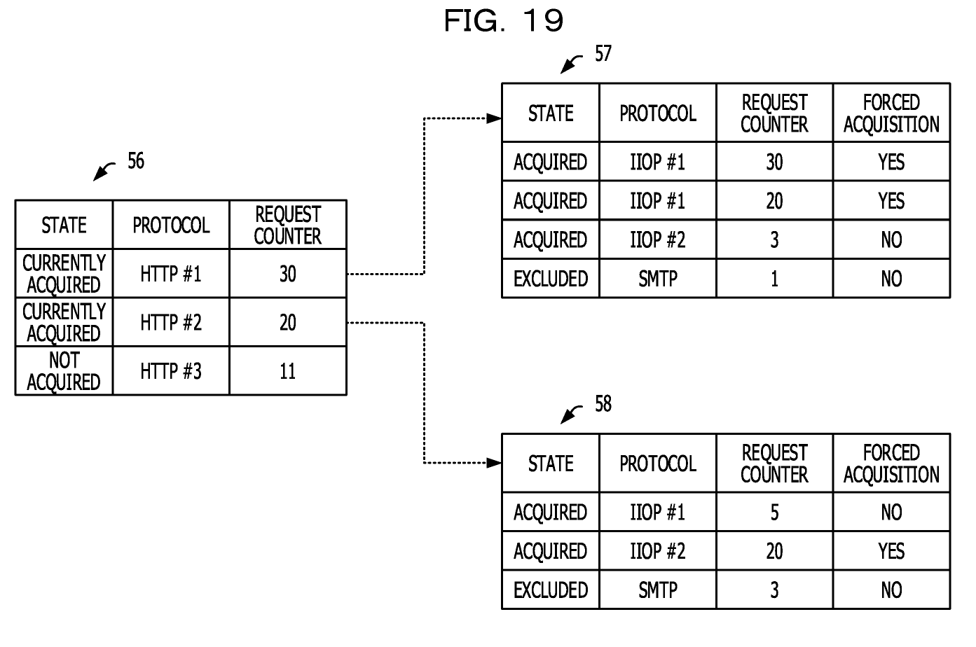

Next, a process of forcibly acquiring transaction data according to the second embodiment is described with reference to FIG. 19. FIG. 19 is a diagram illustrating an example of the rule lists (first and second elements) according to the second embodiment.

A part of the items of the rule list (first element) 51 is omitted in a rule list (first element) 56. In the rule list (first element) 56, the state of a protocol “HTTP #1” indicates “currently acquired”, a request counter for the protocol “HTTP #1” indicates “30”, the state of a protocol “HTTP #2” indicates “currently acquired”, and a request counter for the protocol “HTTP #2” indicates “20”. In the rule list (first element) 56, the state of a protocol “HTTP #3” indicates “not acquired”, and a request counter for the protocol “HTTP #3” indicates “11”.

A part of the items of the rule list (second element) 52 is omitted in a rule list (first element) 57. In the rule list (second element) 57, the state of a protocol “IIOP #1” indicates “acquired”, a request counter for the protocol “IIOP #1” indicates “30”, and forced acquisition for the protocol “IIOP #1” indicates “YES”. In the rule list (second element) 57, the state of another protocol “IIOP #1” indicates “acquired”, a request counter for the other protocol “IIOP #1” indicates “20”, and forced acquisition for the other protocol “IIOP #1” indicates “YES”. In the rule list (second element) 57, the state of a protocol “IIOP #2” indicates “acquired”, a request counter for the protocol “IIOP #2” indicates “3”, and forced acquisition for the protocol “IIOP #2” indicates “NO”. In the rule list (second element) 57, the state of a protocol “SMTP” indicates “excluded”, a request counter for the protocol “SMTP” indicates “1”, and forced acquisition for the protocol “SMTP” indicates “NO”.

A part of the items of the rule list (second element) 52 is omitted in a rule list (first element) 58. In the rule list (second element) 58, the state of the protocol “IIOP #1” indicates “acquired”, a request counter for the protocol “IIOP #1” indicates “5”, forced acquisition for the protocol “IIOP #1” indicates “NO”, the state of the protocol “IIOP #2” indicates “acquired”, a request counter for the protocol “IIOP #2” indicates “20”, and forced acquisition for the protocol “IIOP #2” indicates “YES”. In the rule list (second element) 58, the state of the protocol “SMTP” indicates “excluded”, a request counter for the protocol “SMTP” indicates “3”, and forced acquisition for the protocol “SMTP” indicates “NO”.

The analyzer 22a coordinates with the discovery and the transaction association technique and sets a forced acquisition item of a rule list (second element) to “YES” for an element from which configured data or estimated data has been detected. When the configured data or the estimated data is deleted, the analyzer 22a sets the interested forced acquisition item of the rule list (second element) to “NO”.

Thus, the information processing system 10 coordinates with the discovery and the transaction association technique and achieves high-accuracy collection of transaction data while excluding unwanted transaction data in accordance with a basic rule.

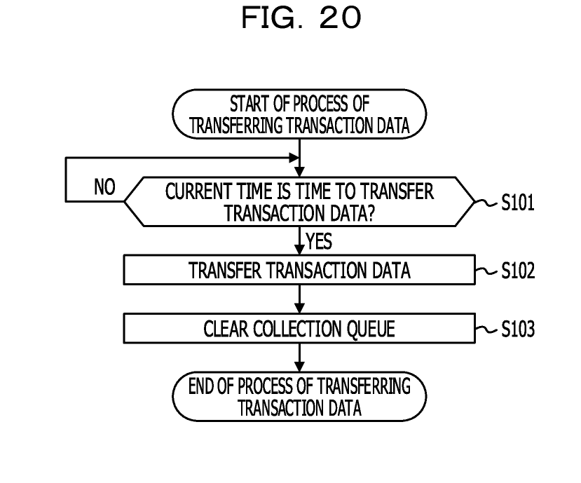

Next, a process of transferring transaction data is described with reference to FIG. 20 and is executed by the analyzer 22 according to the second embodiment. FIG. 20 is a flowchart of the process of transferring transaction data according to the second embodiment.

The process of transferring transaction data is a process of transferring transaction data collected by the observing server 20 to the collecting server 26.

In step S101, the analyzer 22 (specifying unit) periodically or randomly determines the timing of transfer of transaction data to the collecting server 26. If the analyzer 22 determines the timing of the transfer of the transaction data, the analyzer 22 causes the process to proceed to step S102. If the analyzer 22 does not determine the timing of the transfer of the transaction data, the analyzer 22 waits for the timing of the transfer of the transaction data.

In step S102, the analyzer 22 transfers the transaction data stored in the collection queue 25 to the collection server 26.

In step S103, the analyzer 22 clears the collection queue 25. Then, the analyzer 22 terminates the process of transferring transaction data.

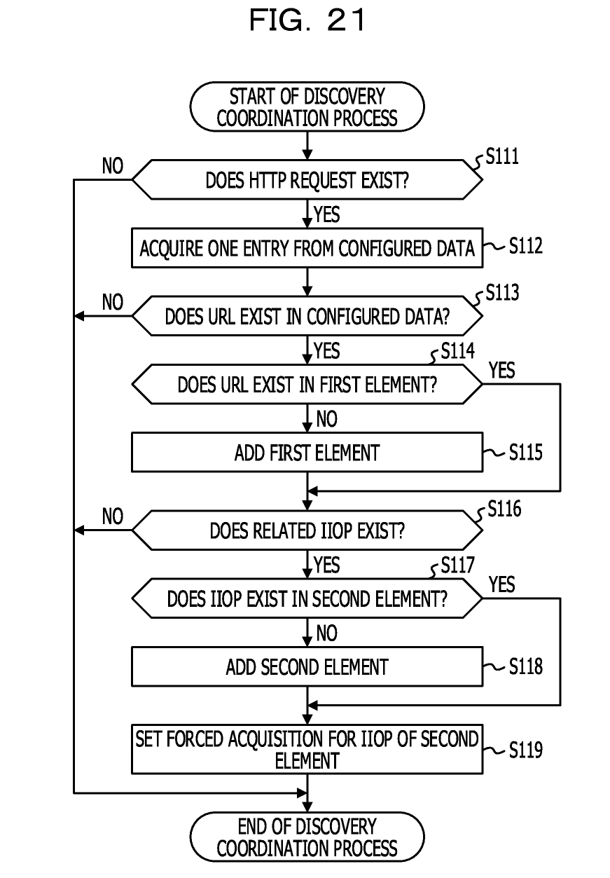

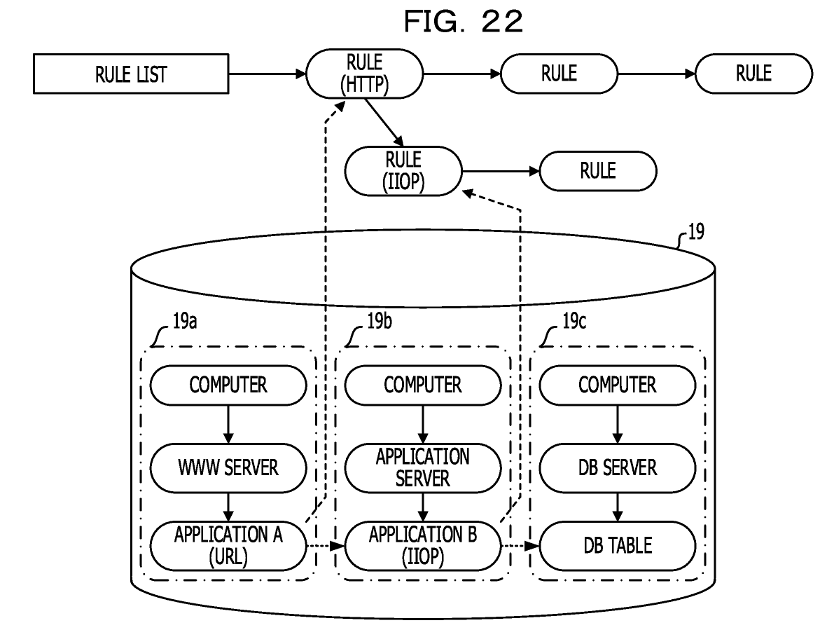

Next, a discovery coordination process that is executed by the analyzer 22a according to the second embodiment is described with reference to FIGS. 21 and 22. FIG. 21 is a flowchart of the discovery coordination process according to the second embodiment. FIG. 22 illustrates an example of the configured data to be referenced for the discovery coordination process according to the second embodiment. Although the discovery coordination process that is executed by the analyzer 22a is described below, the analyzers 22b and 22c may execute the discovery coordination process in the same manner as the analyzer 22a.

The discovery coordination process is a process of brushing up a rule list in coordination with a discovery function. The discovery function is a function of analyzing the structure of a transaction to be observed and is executed by a structure analyzing system (another system). The structure analyzing system causes results (structure analysis data 19a, 19b, and 19c) of analyzing the structure to be stored in configured data (database) 19.

In step S111, the analyzer 22a (specifying unit) determines whether to receive an HTTP request. If the analyzer 22a receives the HTTP request, the analyzer 22a causes the process to proceed to step S112. If the analyzer 22a does not receive the HTTP request, the analyzer 22a terminates the discovery coordination process.

In step S112, the analyzer 22a acquires one entry corresponding to one server unit from the configured data 19.

In step S113, the analyzer 22a determines whether or not the acquired entry includes a URL. If the acquired entry includes the URL, the analyzer 22a causes the process to proceed to step S114. If the acquired entry does not include the URL, the analyzer 22a terminates the discovery coordination process.

In step S114, the analyzer 22a determines whether or not the URL is included in the rule list (first element) 51. If the URL is not included in the rule list (first element) 51 (or is a new URL), the analyzer 22a causes the process to proceed to step S115. If the URL is included in the rule list (first element) 51, the analyzer 22a causes the process to proceed to step S116.

In step S115, the analyzer 22a determines the acquired entry as HTTP data to be acquired, and adds a first element including the new URL to the rule list (first element) 51.

In step S116, the analyzer 22a determines whether or not a related IIOP that is linked to an entry of another server is included in the acquired entry (or whether or not the data is to be transmitted to the other server). If the related IIOP is included in the acquired entry, the analyzer 22a causes the process to proceed to step S117. If the related IIOP is not included in the acquired entry, the analyzer 22a terminates the discovery coordination process.

In step S117, the analyzer 22a determines whether or not the related IIOP is included in the rule list (second element) 52. If the related IIOP is not included in the rule list (second element) 52 (or is a new IIOP), the analyzer 22a causes the process to proceed to step S118. If the related IIOP is included in the rule list (second element) 52, the analyzer 22a causes the process to proceed to step S119.

In step S118, the analyzer 22a adds a second element including the new IIOP to the rule list (second element) 52.

In step S119, the analyzer 22a sets a forced acquisition item of an element corresponding to the new IIOP in the rule list (second element) 52 to “YES”. Then, the analyzer 22a terminates the discovery coordination process.

The configured data 19 is constituent elements of transaction data to be transmitted to a target server, and the structure of the configured data 19 is analyzed by organizing the overall transaction data.

The configured data 19 has structure analysis data 19a in which a computer (computer information), a WWW server (server information), and an application A (URL) are associated with each other, for example. The configured data 19 has structure analysis data 19b in which a computer (computer information), an application server (server information), and an application B (IIOP) are associated with each other, for example. The configured data 19 has structure analysis data 19c in which a computer (computer information), a DB server (server information), and a DB table are associated with each other.

In addition, if a server for transmitting the configured data 19 and a server for receiving the configured data 19 are specified, organization and structure analysis that are executed by the transmitting server are executed by the receiving server, and the configured data 19 is stored in a database.

The configured data 19 includes information of a link from a first server to another server in order to indicate the relationship between the transmitting server and the receiving server.

The information processing system 10 uses the configured data 19 to simplify addition of rules to the rule list (first element) 51 and the rule list (second element) 52.

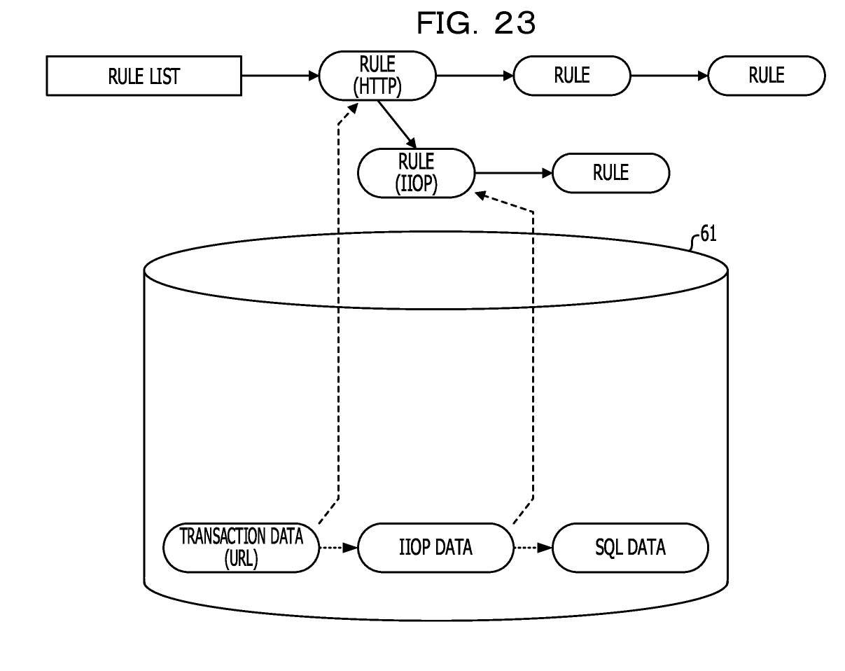

Next, a transaction association technique coordination process that is executed by the analyzer 22a according to the second embodiment is described with reference to FIG. 23. FIG. 23 illustrates an example of estimated data that is referenced for coordination with the transaction association technique according to the second embodiment. Although the transaction association technique coordination process that is executed by the analyzer 22a is described below, the analyzers 22b and 22c may execute the transaction association technique coordination process in the same manner as the analyzer 22a.

The transaction association technique coordination process is a process of brushing up a rule list in coordination with the transaction association technique for estimating the structure of transaction data to be observed. The transaction association technique is a function of estimating the structure of transaction data to be observed and is executed by a structure estimating system (another system). The structure estimating system causes results of estimating the structure to be stored in estimated data (database) 61.

The transaction association technique coordination process may be executed by the same process procedure as the discovery coordination process, and a description thereof is omitted.

### Third Embodiment

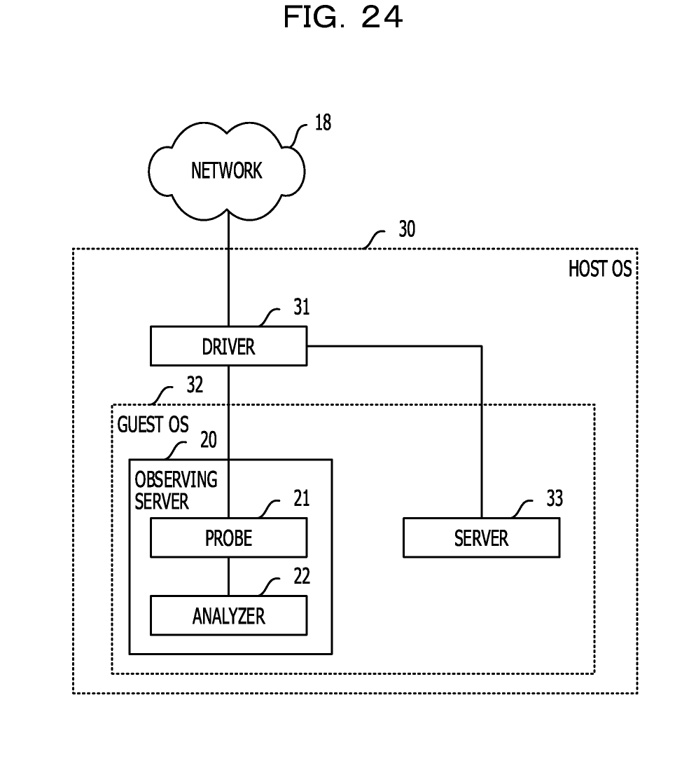

Next, the arrangements of the observing servers 20 according to the third embodiment are described with reference to FIG. 24. FIG. 24 is a diagram illustrating an example of the arrangements of the observing servers 20 of the computers 12, 14, and 16 according to the third embodiment.

The computers 12, 14, and 16 each execute at least one guest OS 32 on the host OS 30. The computers 12, 14, and 16 each execute the observing server 20 and a server 33 on the guest OS 32, while the server 33 is the WWW server 13, the application server 15, or the DB server 17, communicates with an external device through the driver 31, and generates traffic data. The driver 31 controls an NIC (not illustrated) and is connected to and communicates with the networks 18.

Each of the observing servers 20 causes the probe 21 to observe the driver 31 and collects all traffic data of communication between the observing server 20 and an external device through the driver 31. The observing servers 20 acquire, from the collected traffic data, transaction data to be acquired by the analyzers 22.

In this manner, the observing servers 20 collect all traffic data of the servers 33 executed on the guest OS 32.

### Fourth Embodiment

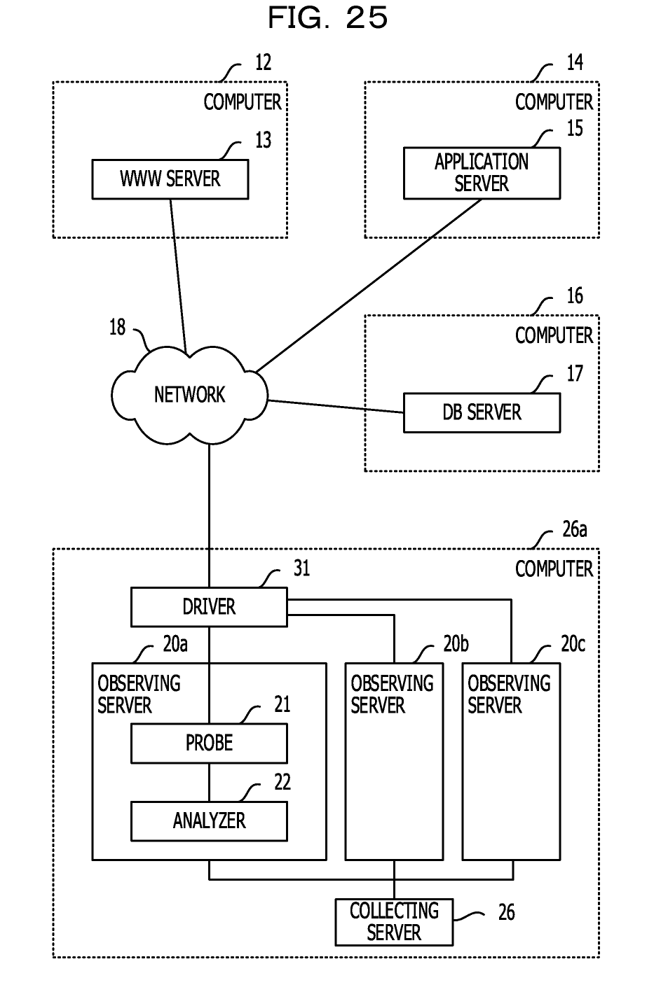

Next, the arrangement of an observing server 20a according to the fourth embodiment is described with reference to FIG. 25. FIG. 25 is a diagram illustrating an example of the arrangement of the observing server 20a of a computer 26a according to the fourth embodiment.

The computer 12 executes the WWW server 13 and connects the WWW server 13 to a network 18. The computer 14 executes the application server 15 and connects the application server 15 to the network 18. The computer 16 executes the DB server 17 and connects the DB server 17 to the network 18.

The computer 26a executes the observing servers 20a, 20b, and 20c and connects the observing servers 20a, 20b, and 20c to the network 18. The computer 26a may collect traffic data of the computers 12, 14, and 16 through a mirror port of a switch (not illustrated) or the like.

The observing servers 20a, 20b, and 20c may collect the traffic data of the computers 12, 14, and 16 through the driver 31. The driver 31 controls an NIC (not illustrated) and is connected to and communicates with the network 18.

The observing servers 20a, 20b, and 20c cause the probes 21 to observe the driver 31 and collect all traffic data of communication between the observing servers 20a, 20b, and 20c and the external devices through the driver 31. The observing servers 20a, 20b, and 20c acquire, from the collected traffic data, transaction data to be acquired by the analyzers 22.

The observing servers 20a, 20b, and 20c coordinate with each other on the computer 26a. The observing servers 20a, 20b, and 20c cause the collected transaction data to be stored in the collecting server 26. In this manner, the collecting server 26 collects all the traffic data of the servers 33 executed on the computers 12, 14, and 16.

The aforementioned processing functions are achieved by a computer. In this case, a program in which the contents of processes to be executed by the functions included in the information processing apparatuses 3, 4, and 5 and computers 12, 14, 16, and 26a are described is provided. The processing functions are achieved on the computer by causing the computer to execute the program. The program in which the contents of the processes are described is stored in a computer-readable recording medium. Examples of the computer-readable recording medium are a magnetic storage device, an optical disc, a magneto-optical recording medium, and a semiconductor memory. Examples of the magnetic storage device are a hard disk device (HDD), a flexible disk, and a magnetic tape. Examples of the optical disc are a DVD, a DVD-RAM, a CD-ROM, and a CD-RW. An example of the magneto-optical recording medium is a magneto-optical disk (MO).

The program is distributed by selling a portable recording medium storing the program, for example. Examples of the portable recording medium are a DVD and a CD-ROM. The program may be stored in a storage device of a server computer and transferred from the server computer to another computer through a network.

The computer that executes the program stores, in the storage device of the computer, the program stored in the portable recording medium or transferred from the server computer. Then, the computer reads the program from the storage device of the computer and executes the processes in accordance with the program. The computer may directly read the program from the portable recording medium and execute the processes in accordance with the program. In addition, every time the program is transferred from the server computer connected to the computer through a network, the computer may execute the processes in accordance with the received program.

At least a part of the processing functions may be achieved by an electronic circuit such as a digital signal processor (DSP), an application specific integrated circuit (ASIC), or a programmable logic device (PLD).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transaction data acquisition method that is executed by an information processing system that includes a first information processing apparatus on which a first server is executed, a second information processing apparatus on which a second server is executed, and a third information processing apparatus on which a third server is executed, comprising:
collecting by the first information processing apparatus, in a first server observation queue, traffic data that is transmitted and received by the first server;
causing the first information processing apparatus to move, to a first server collection queue, first transaction data that includes traffic data of a time period from a client request reception time when the first server receives a request from a client to a client response time when the first server responds to the request from the client;
collecting by the second information processing apparatus, in a second server observation queue, traffic data that is transmitted and received by the second server;
acquiring by the second information processing apparatus, the client request reception time and the client response time from the first server;
causing the second information processing apparatus to move, to a second server collection queue, second transaction data that includes transaction data of a time period from a first server request reception time when the second server receives a request from the first server after the client request reception time to a first server response time when the second server responds to the request from the first server before the client response time;
collecting by the third information processing apparatus, in a third server observation queue, traffic data that is transmitted and received by the third server;
acquiring by the third information processing apparatus, the first server request reception time and the first server response time from the second server; and
causing the third information processing apparatus to move, to a third server collection queue, third transaction data that includes traffic data of a time period from a second server request reception time when the third server receives a request from the second server after the first server request reception time to a second server response time when the third server responds to the request from the second server before the first server response time.

2. The transaction data acquisition method according to claim 1, further comprising:
generating by the first information processing apparatus, a first rule for acquisition of the first transaction data on the basis of the traffic data collected in the first server observation queue; and
specifying by the first information processing apparatus, the first transaction data on the basis of the first rule.

3. The transaction data acquisition method according to claim 1, further comprising:
generating by the second information processing apparatus, a second rule for acquisition of the second transaction data, on the basis of the traffic data collected in the second server observation queue; and
specifying by the second information processing apparatus, the second transaction data on the basis of the second rule.

4. The transaction data acquisition method according to claim 1, further comprising:
generating by the third information processing apparatus, a third rule for acquisition of the third transaction data on the basis of the traffic data collected in the third server observation queue; and
specifying by the third information processing apparatus, the third transaction data on the basis of the third rule.

5. The transaction data acquisition method according to claim 2,
wherein the first rule includes
information listing a request transmitted to a server to be observed, and
information listing a request that has been issued between the request transmitted to the server to be observed and a response by the server to be observed.

6. The transaction data acquisition method according to claim 2,
wherein the first rule includes analysis information obtained by analyzing configurations of the first, second, and third information processing systems.

7. The transaction data acquisition method according to claim 5,
wherein the first rule includes estimated information obtained by estimating structures of the transaction data.

8. The transaction data acquisition method according to claim 2, further comprising:
providing by the first server, a user interface to the client;
providing by the second server, a service based on the request from the first server; and
providing by the third server, a database access service on the basis of the request from the second server.

9. The transaction data acquisition method according to claim 8,
wherein the first server is a world wide web server,
wherein the first transaction data includes traffic data of a time period from the time when a request for a web service is received to the time when a response to the request for the web service is issued.

10. The transaction data acquisition method according to claim 9,
wherein the specifying of the first transaction data includes specifying the first transaction data using the number of times when transaction data is generated between the time when the request for the web service is received and the time when the response to the request for the web service is issued.

11. The transaction data acquisition method according to claim 1, further comprising:
storing, in a transaction data storage unit, the first transaction data stored in the first server collection queue, the second transaction data stored in the second server collection queue, and the third transaction data stored in the third server collection queue; and
deleting, on the basis of a certain requirement, the first transaction data stored in the first server collection queue, the second transaction data stored in the second server collection queue, and the third transaction data stored in the third server collection queue.

12. A computer-readable recording medium storing a program causing an information processing apparatus to execute a process, wherein the information processing apparatus executes a second server in an information processing system including a first server, the second server, and a third server, the process comprising:
collecting, in a first queue, traffic data that is transmitted and received by the second server;
acquiring, from the first server, a client request reception time when the first server receives a request from a client and a client response time when the first server responds to the request from the client; and
moving, to a second queue, traffic data of a time period from a first server request reception time when the second server receives a request from the first server after the client request reception time to a first server response time when the second server responds to the request from the first server before the client response time.

13. An information processing apparatus on which a second server is executed in an information processing system that includes a first server, the second server, and a third server, comprising:
a memory; and
a processor coupled to the memory and configured to
collect, in a first queue, traffic data that is transmitted and received by the second server,
acquire, from the first server, a client request reception time when the first server receives a request from a client and a client response time when the first server responds to the request from the client, and
move, to a second queue, traffic data of a time period from a first server request reception time when the second server receives a request from the first server after the client request reception time to a first server response time when the second server responds to the request from the first server before the client response time.
